(19) United States
(12) Patent Application Publication
(10) Pub. No.: US 2026/0086211 A1
(43) Pub. Date: Mar. 26, 2026

(54) RANGING DEVICE AND RANGING METHOD

(71) Applicant: CANON KABUSHIKI KAISHA, Tokyo (JP)

(72) Inventor: SHOJI TANAKA, Tokyo (JP)

(21) Appl. No.: 19/332,329

(22) Filed: Sep. 18, 2025

(30) Foreign Application Priority Data
Sep. 25, 2024 (JP) 2024-166165

(51) Int. Cl. G01S 7/484; G01S 7/486; G01S 7/4863; G01S 7/4865; G01S 17/14

(52) U.S. Cl. CPC G01S 7/484; G01S 7/4863; G01S 7/4866; G01S 7/4868; G01S 17/14

(57) ABSTRACT

A ranging device includes: a light emission control unit configured to control a light emitting unit that emits a pulse light according to a light emission condition; a light receiving unit configured to detect reflected light emitted from the light emitting unit and reflected by an object and convert the reflected light into a pulse signal; a holding unit configured to hold frequency distribution information in which a count value of the pulse signal is associated with each of a plurality of bin periods obtained by dividing a period from an emission timing of the pulse light to a measurement end timing of the reflected light; and a determination unit configured to determine the light emission condition based on the frequency distribution information.

### BACKGROUND

### Field of the Technology

The present disclosure relates to a ranging device and a ranging method.

### Description of the Related Art

Conventionally, there is a distance measuring technique in which a pulse light is irradiated onto an object and a distance to the object is calculated based on a flight time of light from a light emission timing of the pulse light to a light reception timing of reflected light reflected by the object. LiDAR (Light Detection and Ranging) is known as a typical example of a ranging technique. For example, a direct time of flight (dToF) method or a time gate method may be used for the LiDAR. When distance measurement is performed using such a method, since there is a noise component such as sunlight, a plurality of pulse lights are irradiated, and frequency distribution information indicating a relationship between a flight time of light and the number of times of light reception is generated. Japanese Patent Laid-Open No. 2021-113743 discloses a ranging device that measures a distance to an object based on frequency distribution information.

However, in the ranging device of Japanese Patent Laid-Open No. 2021-113743, an accuracy of the distance measurement may decrease depending on light emission conditions.

### SUMMARY

Therefore, the present disclosure is directed to provide a ranging device and a ranging method capable of accurately measuring a distance.

According to a disclosure of the present specification, there is provided a ranging device including: a light emission control unit configured to control a light emitting unit that emits a pulse light according to a light emission condition; a light receiving unit configured to detect reflected light emitted from the light emitting unit and reflected by an object and convert the reflected light into a pulse signal; an exposure period setting unit configured to set an exposure period for detecting the reflected light; a holding unit configured to hold frequency distribution information in which a count value of the pulse signal is associated with each of a plurality of exposure periods; and a determination unit configured to determine the light emission condition based on the frequency distribution information.

According to a disclosure of the present specification, there is provided a ranging method including: controlling a light emitting unit that emits a pulse light according to a light emitting condition; detecting reflected light emitted from the light emitting unit and reflected by an object and converting the reflected light into a pulse signal; holding, in a holding unit, frequency distribution information in which a count value of the pulse signal is associated with each of a plurality of bin periods obtained by dividing a period from an emission timing of the pulse light to a measurement end timing of the reflected light; and determining the light emission condition based on the frequency distribution information.

According to a disclosure of the present specification, there is provided a ranging method including: controlling a light emitting unit that emits a pulse light according to a light emitting condition; detecting reflected light emitted from the light emitting unit and reflected by an object and converting the reflected light into a pulse signal; setting an exposure period for detecting the reflected light; holding, in a holding unit, frequency distribution information in which a count value of the pulse signal is associated with each of the plurality of exposure periods; and determining the light emission condition based on the frequency distribution information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a ranging device according to a first embodiment.

FIG. 2 is a timing chart illustrating an operation of the ranging device according to the first embodiment.

FIG. 3A, FIG. 3B, FIG. 3C and FIG. 3D are histograms illustrating a relationship between a bin period and a count value of a pulse signal according to the first embodiment.

FIG. 4A, FIG. 4B and FIG. 4C are histograms illustrating a relationship between a bin period and a count value of a pulse signal according to the first embodiment.

FIG. 5A, FIG. 5B, FIG. 5C, FIG. 5D and FIG. 5E are histograms illustrating a relationship between a bin period and a count value of a pulse signal according to a second embodiment.

FIG. 6 is a flowchart of a ranging device according to the second embodiment.

FIG. 7 is a block diagram of a ranging device according to a fourth embodiment.

FIG. 8 is a timing chart illustrating an operation of the ranging device according to the fourth embodiment.

FIG. 9 is a timing chart illustrating a control example of a light emission interval and an exposure period according to the fourth embodiment.

FIG. 10 is a histogram illustrating a relationship between an exposure period and a count value of a pulse signal according to the fourth embodiment.

FIG. 11 is a timing chart illustrating a control example of a light emission interval and an exposure period according to the fourth embodiment.

FIG. 12 is a histogram illustrating a relationship between an exposure period and a count value of a pulse signal according to the fourth embodiment.

FIG. 13A, FIG. 13B and FIG. 13C are diagrams illustrating a light receiving region in a light receiving unit according to a fifth embodiment.

FIG. 14 is a flowchart illustrating an operation of a ranging device according to the fifth embodiment.

FIG. 15A and FIG. 15B are diagrams illustrating a configuration example of a movable body according to a sixth embodiment.

### DESCRIPTION OF THE EMBODIMENTS

### First Embodiment

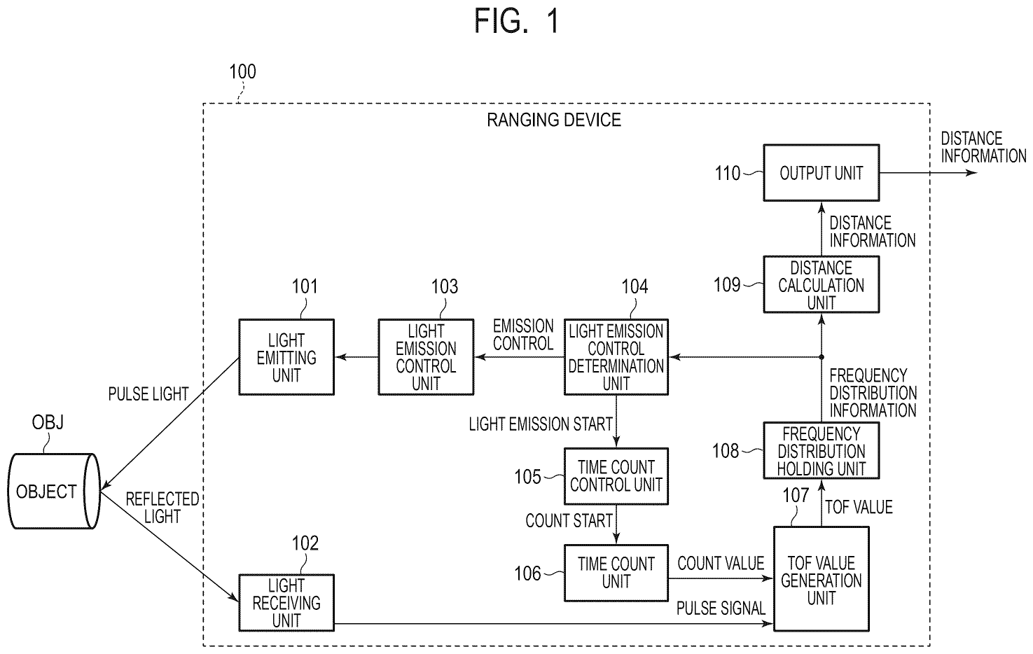

FIG. 1 is a block diagram of a ranging device 100 according to the present embodiment. The ranging device 100 may be a device using a technique of a dToF LiDAR. The ranging device 100 includes a light emitting unit 101, a light receiving unit 102, a light emission control unit 103, a light emission control determination unit (determination unit) 104, a time count control unit 105, a time count unit 106, a TOF value generation unit 107, a frequency distribution holding unit (holding unit) 108, a distance calculation unit 109, and an output unit 110.

The light emitting unit 101 includes a light emitting element, and emits a pulse light such as laser light emitted from the light emitting element toward a measurement target region including an object OBJ. As the light emitting element constituting the light emitting unit 101, an element capable of high-speed modulation such as an LED (Light Emitting Diode) or an LD (Laser Diode) can be applied. The light emitting device may be a VCSEL (Vertical Cavity Surface Emitting Laser). The light emitting element may be a surface light emitting element in which a plurality of VCSELs are arranged in an array. The light emitting unit 101 is preferably configured to emit light having a uniform amount of light to the measurement target region. The light emitting unit 101 may further include an optical element, for example, a lens, for optically converting the light emitted from the light emitting element to be emitted to the measurement target region.

The light receiving unit 102 includes one or a plurality of pixels and receives light incident from the measurement target region. The plurality of pixels constituting the light receiving unit 102 are two-dimensionally arranged, for example, in a matrix, and the distance is two-dimensionally measured at a plurality of points by receiving the reflected light reflected by the object OBJ in the measurement target region. As such a pixel, for example, a CMOS (Complementary Metal-Oxide-Semiconductor) sensor or a SPAD (Single Photon Avalanche Diode) sensor can be applied. In the case of the SPAD sensor, one pulse signal is generated in response to one photon entering an avalanche photodiode. The light incident on the light receiving unit 102 may include ambient light such as sunlight in addition to the reflected light reflected by the object OBJ. The light receiving unit 102 detects an optical signal including light emitted from the light emitting unit 101 and reflected by the object OBJ, converts the optical signal into a pulse signal (electric signal), and outputs the pulse signal to the TOF value generation unit 107. The light receiving unit 102 may further include an optical element, such as a lens, for efficiently guiding the reflected light to the pixel.

The light emission control unit 103 controls the light emitting unit 101 based on a light emission control signal from the light emission control determination unit 104.

The light emission control determination unit 104 determines a light emission condition of the light emitting unit 101 based on a frequency distribution information from the frequency distribution holding unit 108. The light emission condition may be the number of shots (the number of times of light emission) of the light emitting unit 101. The light emission control determination unit 104 outputs a light emission control signal indicating the number of shots to the light emission control unit 103. In addition, the light emission control determination unit 104 outputs a light emission start signal indicating a start of light emission of the light emitting unit 101 to the time count control unit 105.

The time count control unit 105 receives the light emission start signal from the light emission control determination unit 104, and outputs a count start signal indicating start of counting to the time count unit 106.

The time count unit 106 receives the count start signal from the time count control unit 105 and starts counting time. The time count unit 106 may include an oscillation circuit that outputs a clock signal of a constant cycle, and a counter circuit that counts the clock signal from the oscillation circuit. The time count unit 106 outputs a count value indicating an elapsed time to the TOF value generation unit 107.

The TOF value generation unit 107 receives the count value of the elapsed time from the time count unit 106, further receives the pulse signal from the light receiving unit 102 and counts the pulse signal according to the clapsed time from the light emission. Then, the TOF value generation unit 107 generates a count value (TOF value) obtained by counting the pulse signal for each pixel. The TOF value generation unit 107 outputs the TOF value to the frequency distribution holding unit 108.

The frequency distribution holding unit 108 receives the TOF value from the TOF value generation unit 107, generates frequency distribution information for each pixel, and holds the frequency distribution information. In the frequency distribution information, the count value (TOF value) of the pulse signal is associated with each of a plurality of bin periods. Here, the plurality of bin periods are obtained by dividing a period from an emission timing of the pulse light to a measurement end timing of the reflected light. Each of the plurality of bin periods corresponds to a time of flight of the light. In the frequency distribution information, the bin period is defined as a class, the count value of the pulse signal is defined as a frequency, and the class and the frequency are associated with each other. The frequency distribution holding unit 108 records the frequency distribution information in a memory such as a RAM (Random Access Memory) or a counter circuit. In this way, by temporarily recording, it is not necessary to read out a detection information of photons one by one from an outside of the ranging device 100, and it is possible to realize the distance measurement with high responsiveness and less photon count loss. The frequency distribution holding unit 108 outputs the frequency distribution information to the light emission control determination unit 104 and the distance calculation unit 109.

The distance calculation unit 109 receives the frequency distribution information from the frequency distribution holding unit 108 and calculates the distance of each pixel for each frame period described later. Specifically, the distance calculation unit 109 detects, for each pixel, the class in which the frequency is a maximum (peak value) from the frequency distribution information. The light incident on the light receiving unit 102 may include environmental light such as sunlight in addition to the reflected light reflected by the object OBJ. Therefore, the distance calculation unit 109 detects a peak value from the frequency distribution information and detects the class (bin period) corresponding to the frequency of the peak value. The detected bin period is distance information (time information) corresponding to a flight time of light from when the pulse light is emitted from the light emitting unit 101 toward the measurement target region to when the reflected light from the object OBJ in the measurement target region is received by the light receiving unit 102. The distance calculation unit 109 outputs distance information (time information) to the output unit 110.

The output unit 110 outputs the distance information from the distance calculation unit 109 to an external device (not illustrated). The output unit 110 outputs the distance information to the external device every time one or a plurality of frame periods elapse.

The external device calculates the distance from the ranging device 100 to the object OBJ based on the distance information from the output unit 110.

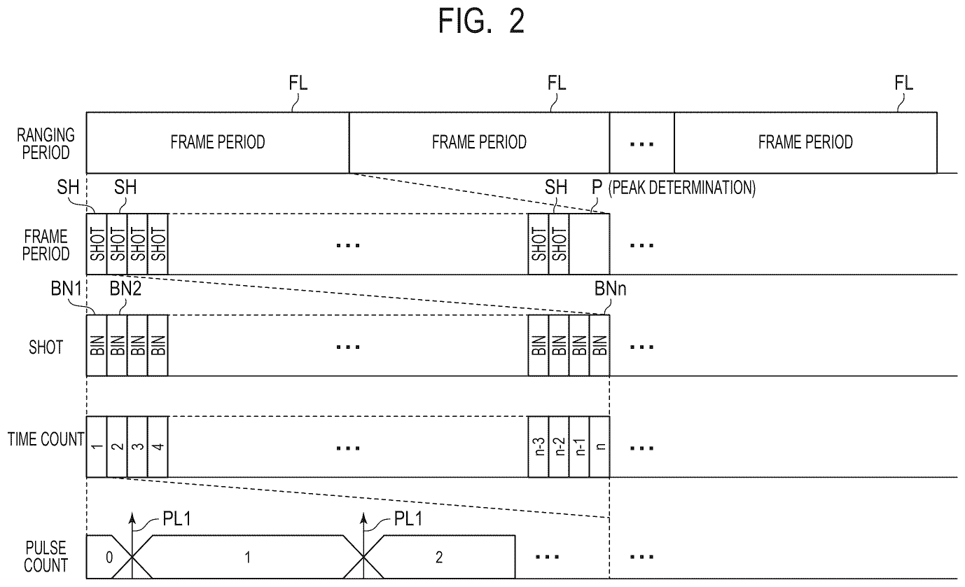

FIG. 2 is a timing chart illustrating an operation of the ranging device 100 according to the present embodiment. In a ranging period, the ranging device 100 performs a ranging operation once. One ranging period includes a plurality of frame periods FL. Each frame period FL is a period in which distance information indicating a distance from the ranging device 100 to the object OBJ is acquired. The distance measurement is performed once based on the distance information in each frame period FL.

The frame period FL includes a plurality of shot periods SH and a peak determination period P. The shot is defined as emitting pulse light once from the light emitting unit 101 toward the measurement target region. The shot period SH is a period in which pulse light is emitted once. The frequency distribution holding unit 108 integrates the frequency distribution information for each shot period SH. The peak determination period P is a period in which the distance calculation unit 109 determines a bin period in which the count value of the frequency distribution information is the maximum (peak value).

The shot period SH includes a plurality of bin periods BN1, BN2, . . . , BNn (n is a positive integer). The bin periods are obtained by dividing a period from the light emission by the light emitting unit 101 (an emission timing of a pulse light) to the measurement end timing of the reflected light. Each of the bin periods corresponds to a time of flight of the light. One bin period indicates a period in which the frequency distribution holding unit 108 counts pulse signals. The distance to the object OBJ can be calculated in the external device by identifying the bin period in which the count value of the pulse signal is the peak value in the distance calculation unit 109.

The time counts 1-n correspond to bin periods BN1-BNn. The pulse count indicates a pulse signal from the light receiving unit 102. When one photon is incident on the light receiving unit 102, one pulse signal PL1 is output. The TOF value generation unit 107 counts up the count value for each pulse signal PL1 in each bin period. When transitioning to the next bin period, the count value is cleared to 0. Here, two pulse signals PL1 are output in the bin period BN1, and the count value of the bin period BN1 becomes “2”. The count value “2” represents the number of photons detected in the bin period BN1.

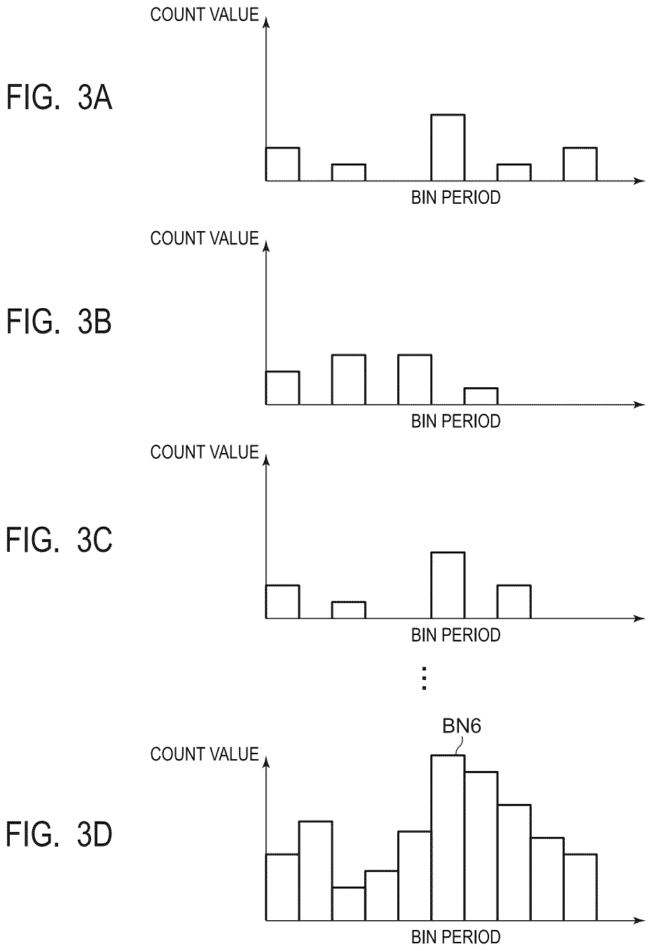

FIGS. 3A to 3D are histograms (frequency distribution information) illustrating a relationship between a bin period and a count value of a pulse signal according to the present embodiment. The horizontal axis indicates a bin period, and one class of the histogram corresponds to one bin period. The vertical axis indicates the count value of the pulse signal detected in each bin period. The histograms of FIGS. 3A to 3D are histograms for one pixel. FIGS. 3A, 3B, and 3C are histograms of the count values of the pulse signals in the first shot, the second shot, and the third shot, respectively. The first shot is the pulse light emitted in the first shot period SH. The second shot is the pulse light emitted in a second shot period SH after the first shot period SH. The third shot is the pulse light emitted in a third shot period SH after the second shot period SH. FIG. 3D is a histogram obtained by integrating the count values of all shots in one frame.

In the first shot of FIG. 3A, the pulse signal is detected in five bin periods. In the second shot of FIG. 3B, the pulse signal is detected in four bin periods. In the third shot of FIG. 3C, the pulse signal is detected in four bin periods. In FIGS. 3A, 3B, and 3C, the bin periods may not coincide with each other, and the count values of the pulse signals detected in the bin periods may not coincide with each other. This is due to the count value of the ambient light other than the reflected light from the object OBJ.

The frequency distribution holding unit 108 integrates the count values of the pulse signals in all shots including the first to third shots for each bin period. In the peak determination period P of FIG. 2, the distance calculation unit 109 determines a bin period in which the count value becomes a peak in the histogram obtained by integrating all shots. In the histogram of FIG. 3D, the count value of the bin period BN6 has a peak. Accordingly, there is a high possibility that the bin period BN6 includes the count value of the reflected light from the object OBJ. The distance from the ranging device 100 to the object OBJ is calculated based on the time information of the bin period BN6.

As illustrated in FIGS. 3A, 3B, and 3C, even when the count value due to the ambient light is included, the bin period in which the possibility of the reflected light from the object OBJ is high can be accurately determined by integrating the count values of the plurality of shots. In addition, even when the pulse light emitted from the light emitting unit 101 is weak, it is possible to accurately determine the bin period in which the possibility of the reflected light from the object OBJ is high.

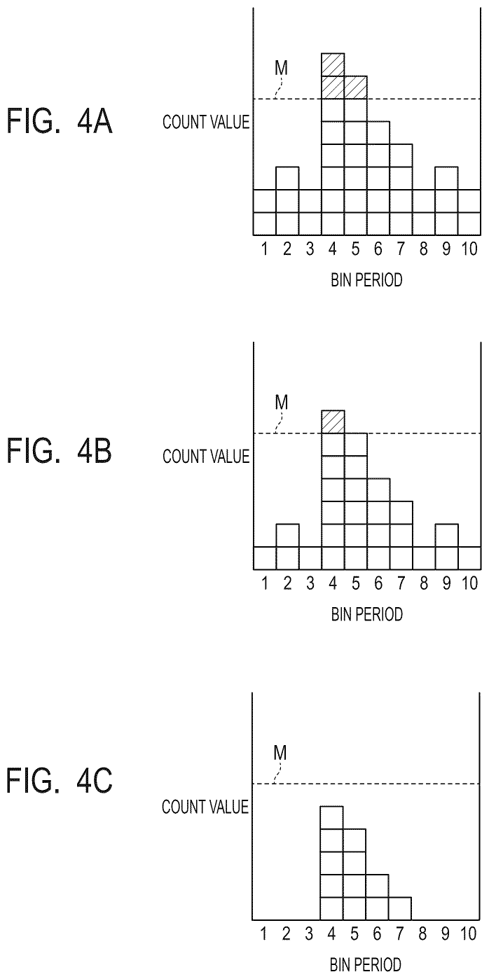

FIGS. 4A to 4C are histograms illustrating a relationship between a bin period and a count value of a pulse signal according to the present embodiment. The histogram is for one pixel. For illustration purposes, the number of bin periods is 10, and numbers 1 to 10 indicate bin periods BN1 to BN10.

The count value is recorded in a counter circuit or a memory of the frequency distribution holding unit 108 for each bin period. Here, in consideration of the manufacturing cost and size reduction of the ranging device 100, there is a case where the recording capacity of the counter circuit and the memory cannot be sufficiently allocated. Therefore, the number of photons received by the light receiving unit 102 may reach a maximum value (upper limit value M) of the count value that can be recorded in the frequency distribution holding unit 108.

FIG. 4A illustrates a histogram of a first frame period, and the count value reaches the upper limit value M in the bin periods 4 and 5. In FIG. 4A, a count value up to the upper limit value M is represented by a white box, and a count value exceeding the upper limit value M is represented by a hatched box. Although the bin period 4 is larger than the bin period 5 in the number of photons received by the light receiving unit 102, the bin period 4 and the bin period 5 are the same in the count value recorded in the frequency distribution holding unit 108 due to the limitation of the recording capacity. That is, a plurality of (two) peak values exist in the histogram.

When the plurality of peak values reach the upper limit value M, the light emission control determination unit 104 changes the light emission condition of the light emitting unit 101. Specifically, the light emission control determination unit 104 reduces the number of shots in the second frame period after the first frame period to be smaller than the number of shots in the first frame period. Specifically, the light emission control determination unit 104 sets the number of shots obtained by subtracting 1 from the number of shots in the first frame period as the number of shots in the second frame period. The light emission control determination unit 104 outputs a light emission control signal indicating the number of shots after subtraction to the light emission control unit 103. The light emission control unit 103 controls the light emitting unit 101 based on the number of shots after subtraction in the second frame period.

FIG. 4B illustrates a histogram after the subtraction processing of the number of shots is performed over a plurality of frame periods. As the number of shots decreases, the count value of the histogram of FIG. 4B decreases as a whole from the count value of the histogram of FIG. 4A. However, in the bin periods 4 and 5 of FIG. 4B, the peak value still reaches the upper limit value M. Therefore, the light emission control determination unit 104 further performs a process of subtracting the number of shots.

FIG. 4C illustrates a histogram after the subtraction processing of the number of shots is further performed over a plurality of frame periods. The count value of the histogram of FIG. 4C is decreased as a whole from the count value of the histogram of FIG. 4B. In FIG. 4C, since the peak value is less than the upper limit value M, the light emission control determination unit 104 ends the process of subtracting the number of shots. Accordingly, it is possible to avoid a situation in which the peak value cannot be determined due to the plurality of peak values reaching the upper limit value M.

As described above, the ranging device 100 according to the present embodiment includes the light emission control determination unit 104 that determines the light emission condition of the light emitting unit 101 based on the frequency distribution information. Accordingly, the ranging device 100 can generate more appropriate frequency distribution information according to the light emission condition, and can accurately measure the distance to the object OBJ.

As illustrated in FIGS. 4A to 4C, the light emission control determination unit 104 determines the light emission condition for each frame period so that the peak value becomes smaller than the upper limit value M. Here, the light emission control determination unit 104 reduces the number of shots of the light emitting unit 101 by a predetermined number (for example, “1”) for each frame period. Accordingly, since the number of photons detected in the light receiving unit 102 can be reduced, it is possible to suppress a plurality of peak values from reaching the upper limit value M in the frequency distribution holding unit 108. Therefore, since it is possible to suppress detection of a plurality of peak values, the distance calculation unit 109 can accurately determine the peak values. As a result, the ranging device 100 can accurately measure the distance to the object OBJ based on the frequency distribution information.

Although it has been described that the number of shots obtained by subtracting 1 from the number of shots in the first frame period is used as the number of shots in the second frame period, the number of shots is not limited thereto. For example, instead of subtracting 1, G (2≤G<the number of shots in the first frame period) may be subtracted.

The start condition of the process of subtracting the number of shots is not limited to the example in which the plurality of peak values reach the upper limit value M, and may be, for example, a case in which one peak value reaches the upper limit value M.

In addition, although an example in which the peak value that reaches the upper limit value M is 0 has been described as the termination condition of the process of subtracting the number of shots, the termination condition is not limited thereto, and a case in which one peak value that reaches the upper limit value M may be used.

In addition, although an example in which the upper limit value M is the maximum value of the count values that can be recorded in the frequency distribution holding unit 108 has been described, the present embodiment is not limited thereto, and for example, the upper limit value M may be smaller than the maximum value.

In addition, the light emission control determination unit 104 may perform control to return the subtracted number of shots to an initial value at a predetermined timing. The initial value may be the maximum number of shots in one frame period. The predetermined timing may be a timing at which one ranging period ends and transitions to the next ranging period but may be other timings.

### Second Embodiment

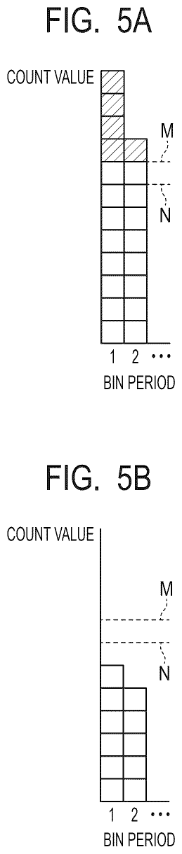

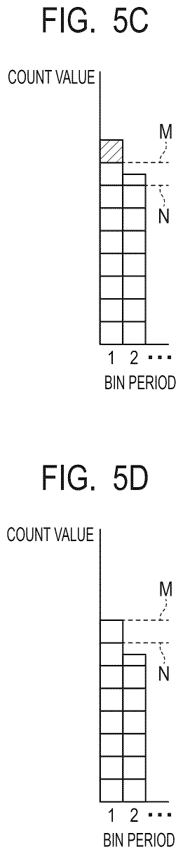

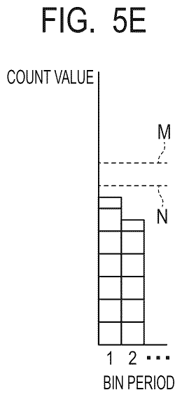

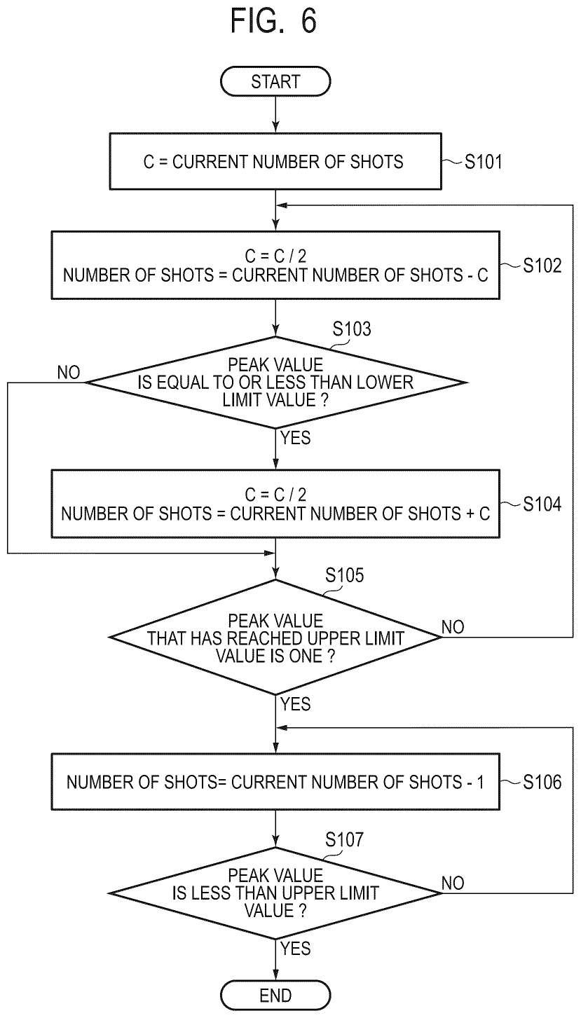

The present embodiment is different from the first embodiment in that the number of shots is increased. The hardware configuration of the ranging device according to the present embodiment is the same as that of the ranging device 100 according to the first embodiment. FIGS. 5A to 5E are histograms obtained by integrating count values of pulse signals of all shots in one frame period. In the histograms of FIGS. 5A to 5E, only the bin periods 1 and 2 in which the peak value reaches the upper limit value M are illustrated for explanation. FIG. 6 is a flowchart illustrating an operation example of the ranging device 100 according to the present embodiment. In the following description, the operation of the ranging device 100 will be described using the histograms of FIGS. 5A to 5E with reference to flowcharts.

As illustrated in FIG. 5A, when the peak value reaches the upper limit value M, in step S101, the light emission control determination unit 104 sets the current number of shots to a variable C indicating the number of shots in one frame period. The current number of shots may be, for example, the maximum number of shots in one frame period.

In step S102, the light emission control determination unit 104 sets a value obtained by dividing the variable C by the divisor “2” to the variable C. Then, the light emission control determination unit 104 changes the number of shots in the next frame period to a value obtained by subtracting the variable C from the current number of shots. As a result, the number of shots in the next frame period becomes one half of the number of shots in the current frame period. When the next frame period is processed with this number of shots, as illustrated in the histogram of FIG. 5B, the peak value is equal to or less than the lower limit value N lower than the upper limit value M. Here, the lower limit value N is a value that prevents the peak value from becoming too small when the number of shots is significantly reduced.

In step S103, the light emission control determination unit 104 determines whether the peak value is equal to or less than the lower limit value N. When the peak value is larger than the lower limit value N (step S103; NO), the process proceeds to step S105. When the peak value is equal to or less than the lower limit value N (step S103; YES), the process proceeds to step S104.

In step S104, the light emission control determination unit 104 sets a value obtained by dividing the variable C by the divisor “2” to the variable C. That is, since the variable C in step S101 is set to ½ in step S102 and is further set to ½ in step S104, as a result, a value obtained by dividing the variable C in step S101 by the divisor “4” is set to the variable C. The light emission control determination unit 104 changes the number of shots in the next frame period to a value obtained by adding the variable C to the current number of shots. As a result, the number of shots in the next frame period is larger than the number of shots in the current frame period. When the next frame period is processed with this number of shots, as illustrated in the histogram of FIG. 5C, only the peak value of the bin period 1 reaches the upper limit value M. The process proceeds to step S105.

In step S105, the light emission control determination unit 104 determines whether the peak value that has reached the upper limit value M is one. When the peak value that has reached the upper limit value M is not one (step S105; NO), the processing of steps S102 to S104 is repeated until the peak value that has reached the upper limit value M becomes one. The above-described steps S102 to S104 are processing of setting the peak value that has reached the upper limit value M to one by a small number of processing steps. When one peak value reaches the upper limit value M (step S105; YES), the process proceeds to step S106.

In step S106, the light emission control determination unit 104 sets a value obtained by subtracting 1 from the current number of shots as the number of shots in the next frame period. When the pulse light is emitted in the next frame period with this number of shots, as illustrated in the histogram of FIG. 5D, the peak value of the bin period 1 still reaches the upper limit value M.

In step S107, the light emission control determination unit 104 determines whether the peak value is less than the upper limit value M. If the peak value is not less than the upper limit value M (step S107; NO), the process returns to step S106, and a value obtained by subtracting 1 from the current number of shots is set as the number of shots in the next frame period. Then, the process of subtracting the number of shots is repeated until the peak value becomes less than the upper limit value M.

When the peak value is less than the upper limit value M (step S107; YES), the process of changing the number of shots is ended. In this case, as illustrated in the histogram of FIG. 5E, the peak value is less than the upper limit value M, and as illustrated in the histogram of FIG. 5B, the peak value is prevented from becoming too small.

As described above, when a plurality of peak values have reached the upper limit value M in the current frame period, the light emission control determination unit 104 reduces the number of shots in the current frame period by a number (for example, C/2) larger than a predetermined number in the next frame period. The number larger than the predetermined number is a value calculated from the number of shots in the current frame period. Specifically, the number larger than the predetermined number is a value obtained by dividing the number of shots in the current frame period by a predetermined divisor (for example, “2”). As a result, the ranging device 100 can end the subtraction processing of the number of shots in a smaller frame period and thus can efficiently perform distance measurement.

When the peak value is equal to or less than the lower limit value in the current frame period, the light emission control determination unit 104 increases the number of shots in the current frame period in the next frame period. By increasing the number of shots when the number of shots is subtracted too much, it is possible to prevent the peak value from becoming excessively small.

In the present embodiment, an example in which the number of shots is reduced by one in step S106 has been described, but the present embodiment is not limited thereto, and for example, the number of shots may be reduced by N(2≤N<C (maximum number of shots)).

### Third Embodiment

The present embodiment differs from the first and second embodiments in that emission intensity is used as the emission condition. The hardware configuration of the ranging device according to the present embodiment is the same as that of the ranging device 100 according to the first embodiment.

The light emission control determination unit 104 determines light emission intensity of the light emitting unit 101 based on the frequency distribution information. Specifically, when a plurality of peak values have reached the upper limit value M in the first frame period, the light emission control determination unit 104 reduces the light emission intensity of the light emitting unit 101 in the first frame period by a predetermined number in the second frame period. Specifically, the light emission intensity of the light emitting unit 101 in the second frame period is reduced to 90% of the light emission intensity of the light emitting unit 101 in the first frame period. The light emission control determination unit 104 outputs a light emission control signal indicating the light emission intensity to the light emission control unit 103.

Based on the light emission control signal, the light emission control unit 103 controls the light emitting unit 101 to emit a pulse light at a specified light emission intensity.

As described above, according to the ranging device 100 of the present embodiment, when the plurality of peak values reach the upper limit value M, the light emission control determination unit 104 reduces the light emission intensity of the light emitting unit 101. Accordingly, since the number of photons reaching the light receiving unit 102 can be reduced, the transition of the histograms like that in FIGS. 4A to 4C of the first embodiment can be expected. As a result, the distance calculation unit 109 can accurately determine the peak value.

Although an example in which the light emission control determination unit 104 reduces the light emission intensity when the plurality of peak values reach the upper limit value M has been described, the present embodiment is not limited thereto, and the light emission intensity may be reduced when one peak value reaches the upper limit value M.

In addition, although an example in which the emission intensity is reduced to 90% has been described, the present embodiment is not limited thereto, and other reduction rates such as 95% or 85% may be used.

In addition, instead of making the reduction rate of the emission intensity constant, the reduction rate of the emission intensity may be changed for each frame period in the same manner as the processing described in the second embodiment.

In addition, in the second embodiment, the light emission control determination unit 104 may reduce the light emission intensity by a number larger than a predetermined number instead of the number of shots or may reduce both the number of shots and the light emission intensity by a number larger than the predetermined number. The number greater than the predetermined number may be a value obtained by dividing the emission intensity by a predetermined divisor.

In the second embodiment, the light emission control determination unit 104 may increase the light emission intensity instead of the number of shots. The light emission control determination unit 104 may increase both the number of shots and the light emission intensity.

### Fourth Embodiment

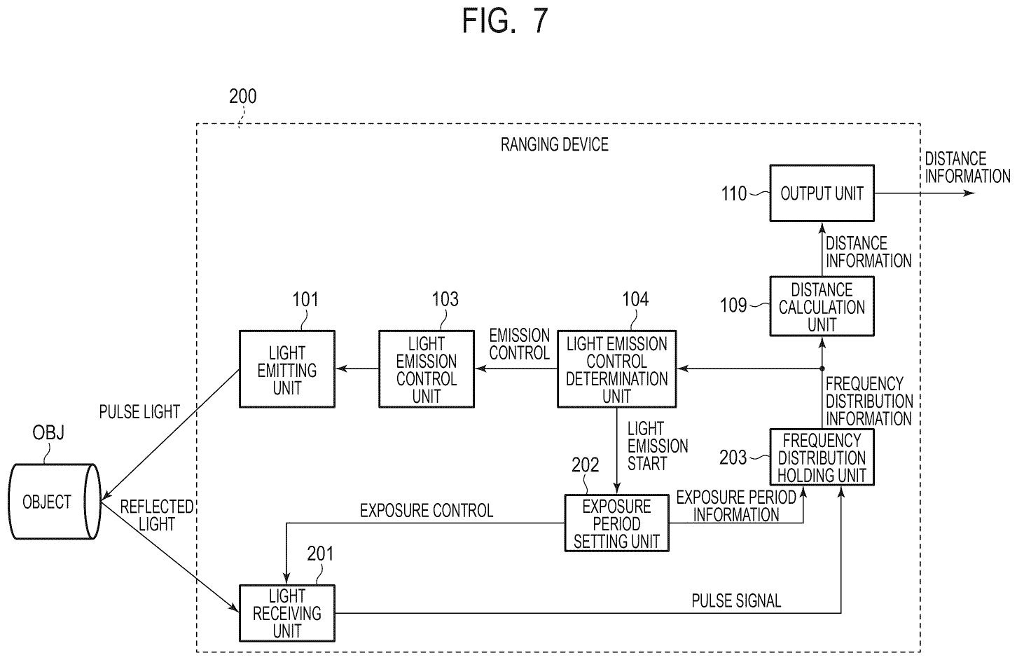

FIG. 7 is a block diagram of the ranging device 200 according to the present embodiment. The ranging device 200 is different from the ranging device 100 using the dToF LiDAR technology according to the first embodiment in that it is a device using a time gate LiDAR technology. In the ranging device 200 according to the present embodiment, components having the same functions as those of the ranging device 100 according to the first embodiment are denoted by the same reference numerals, and detailed description thereof will be omitted.

The ranging device 200 includes a light emitting unit 101, a light receiving unit 201, a light emission control unit 103, a light emission control determination unit 104, an exposure period setting unit 202, a frequency distribution holding unit 203, a distance calculation unit 109, and an output unit 110.

The light emission control determination unit 104 determines a light emission interval for causing the light emitting unit 101 to emit light based on the frequency distribution information from the frequency distribution holding unit 203. The light emission control determination unit 104 outputs a light emission control signal indicating a light emission interval to the light emission control unit 103. In addition, the light emission control determination unit 104 outputs a light emission start signal indicating a start of light emission of the light emitting unit 101 to the exposure period setting unit 202.

The exposure period setting unit 202 sets an exposure period for detecting reflected light from the object OBJ in the light receiving unit 201 based on the light emission start signal from the light emission control determination unit 104. Specifically, the exposure period setting unit 202 sets, for each emission of pulse light by the light emitting unit 101, any one of a plurality of exposure periods determined according to a time from an emission of light to a detection of a pulse light to the light receiving unit 201. Here, during the exposure period, a signal based on incident light is generated in the light receiving unit 201. The exposure period setting unit 202 generates an exposure control signal for controlling the timing of the start and end of the exposure period in the light receiving unit 201, and outputs the exposure control signal to the light receiving unit 201. The exposure period setting unit 202 outputs exposure period information indicating the set exposure period to the frequency distribution holding unit 203.

When light enters in the exposure period indicated by the exposure control signal from the exposure period setting unit 202, the light receiving unit 201 converts the received light into a pulse signal and outputs the pulse signal to the frequency distribution holding unit 203.

The frequency distribution holding unit 203 receives the exposure period information from the exposure period setting unit 202 and further receives a pulse signal from each pixel of the light receiving unit 201 to generate and hold frequency distribution information for each pixel. The frequency distribution holding unit 203 has a counter and counts pulse signals for each exposure period based on the exposure period information output from the exposure period setting unit 202 and the pulse signals output from the light receiving unit 201. Then, the frequency distribution holding unit 203 generates the frequency distribution information in which the count value of the pulse signal is associated with each of the exposure periods. That is, the frequency distribution holding unit 203 sets the exposure period as a class, sets the count value obtained by counting pulse signals as a frequency, and generates the frequency distribution information in which the class and the frequency are associated with each other. The frequency distribution holding unit 203 outputs the frequency distribution information to the distance calculation unit 109.

The distance calculation unit 109 receives the frequency distribution information from the frequency distribution holding unit 203 and calculates a distance of each pixel for each frame period.

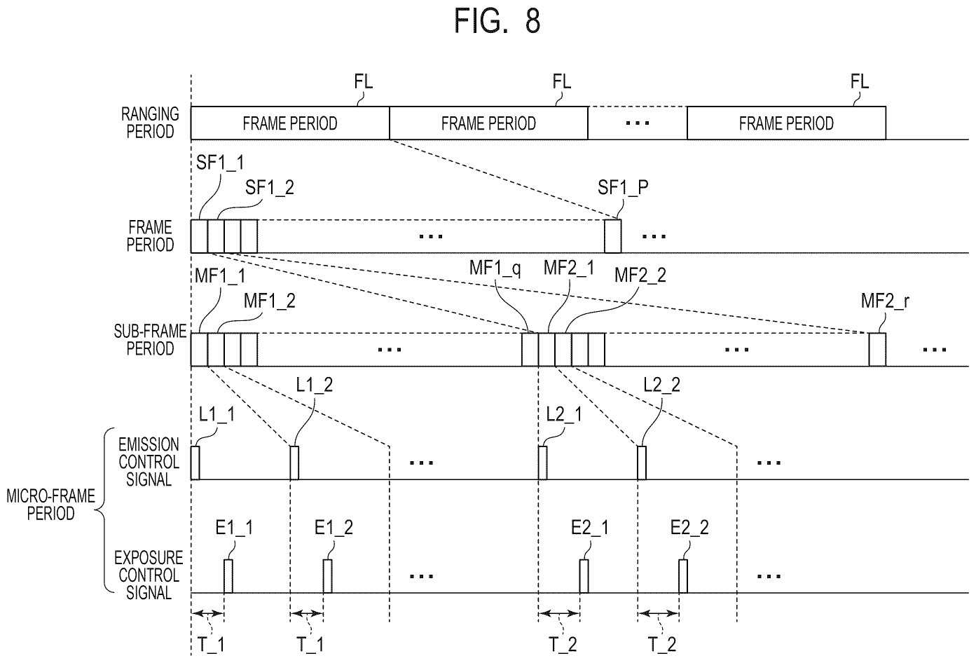

FIG. 8 is a timing chart illustrating an operation of the ranging device 200 according to the present embodiment. In FIG. 8, the horizontal axis represents time. FIG. 8 illustrates a frame period for acquiring a frame, a sub-frame period for acquiring a sub-frame used for generating a frame, and a micro-frame period for acquiring a micro-frame used for generating a sub-frame. FIG. 8 illustrates a light emission control signal for controlling the light emission timing of the light emitting unit 101 and an exposure control signal for controlling the exposure period in the light receiving unit 201 in the micro-frame period.

The ranging period in FIG. 8 is a period in which the ranging device 200 performs a ranging operation once. One ranging period includes a plurality of frame periods FL. Each frame period FL is a period in which distance information indicating a distance from the ranging device 200 to the object OBJ is acquired. The distance measurement is performed once based on the distance information in each frame period FL.

The frame period FL includes a plurality of sub-frame periods SF1_1, SF1_2, . . . , SF1_p. The number of sub-frame periods in the frame period FL is p (p is a positive integer).

The sub-frame period SF1_1 includes a plurality of micro-frame periods MF1_1, MF1_2, . . . , MF1_q. The number of micro-frame periods in the sub-frame period SF1_1 is q (q is a positive integer).

The sub-frame period SF1_2 includes a plurality of micro-frame periods MF2_1, MF2_2, . . . , MF2_r. The number of micro-frame periods in the sub-frame period SF1_2 is r (r is a positive integer). The number r and the number q of the micro-frame periods may be different or the same.

The light emission control signal input to the light emitting unit 101 and the exposure control signal input to the light receiving unit 201 in one micro-frame period are indicated. The light emitting unit 101 emits light in a period in which the light emission control signal from the light emission control unit 103 is at a high level. The light receiving unit 201 detects incident light in an exposure period in which an exposure control signal from the exposure period setting unit 202 is at a high level.

In the micro-frame period MF1_1, the light emitting unit 101 emits light at a light emission timing L1_1, and the light receiving unit 201 receives light in an exposure period E1_1. In the micro-frame period MF1_2, the light emitting unit 101 emits light at the light emission timing L1_2, and the light receiving unit 201 receives light in an exposure period E1_2. The light emitting unit 101 emits light with a light emission interval between the light emission timing L1_1 and the light emission timing L1_2. Since the micro-frame period MF1_1 and the micro-frame period MF1_2 are included in the same sub-frame period SF1_1, the exposure period E1_1 and the exposure period E1_2 are set to the same timing from the light emission. That is, the length of the period T_1 from the start of the light emission timing L1_1 to the start of the exposure period E1_1 is the same as the length of the period T_1 from the start of the light emission timing L1_2 to the start of the exposure period E1_2. These periods T_1 correspond to the flight time of the light from when the light emitting unit 101 emits the light toward the measurement target region until the light receiving unit 201 receives the reflected light reflected by the object OBJ included in the measurement target region.

In the micro-frame period MF2_1, the length of the period T_2 from the start of the light emission timing L2_1 to the start of the exposure period E2_1 is the same as the length of the period T_2 from the start of the light emission timing L2_2 to the start of the exposure period E2_2. The sub-frame period of the period T_1 and the sub-frame period of the period T_2 are different and thus the periods T_1 and T_2 have different timings from the light emission. The difference between the length of the period T_1 and the length of the period T_2 corresponds to the length of one exposure period, and when one sub-frame period is shifted, the timing of outputting the exposure control signal is shifted by the length of one exposure period. However, the relationship between the sub-frame period and the timing of outputting the exposure control signal is not limited to this.

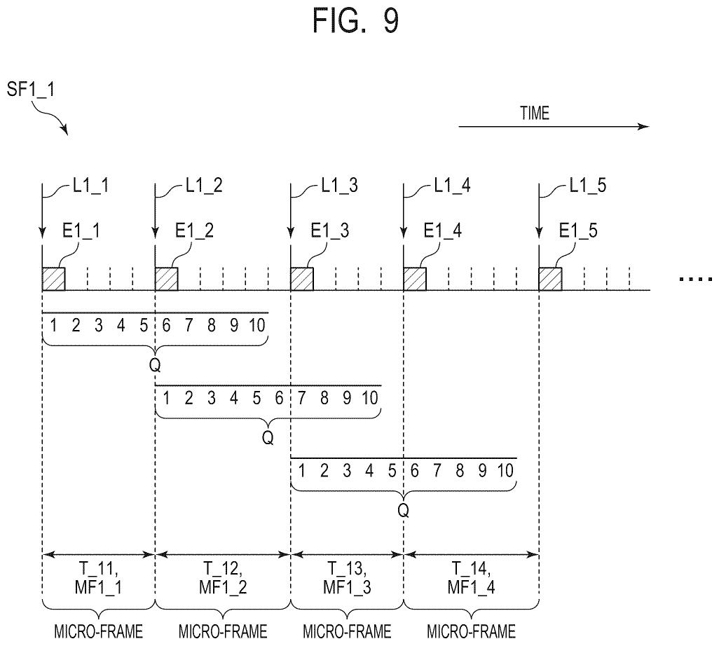

FIG. 9 is a timing chart illustrating a control example of a light emission interval and an exposure period according to the present embodiment. A measurement period Q is a period from when the pulse light is emitted from the light emitting unit 101 to when the reflected light caused by the pulse light can be detected by the light receiving unit 102. The measurement period Q is a period in which the reflected light caused by the pulse light is sufficiently weakened and does not affect other distance measurement results. That is, if the light is emitted with the measurement period Q, an influence of disturbance light from the other light sources can be suppressed, and thus self-interference can be suppressed. The measurement period Q is a period obtained by multiplying the exposure period by an integer. Here, the measurement period Q is a period obtained by multiplying the exposure period by 10 and corresponds to the length of 10 exposure periods. The measurement period Q is represented by distance values 1 to 10. The distance values 1 to 10 are proportional to a distance from when the pulse light is emitted from the light emitting unit 101 to when the reflected light reflected by the object OBJ is received by the light receiving unit 201. It can be said that the distance values 1 to 10 are values proportional to the flight time of the light such as the above-described periods T_1 and T_2. The distance values 1 to 10 correspond to each of the exposure periods. That is, the distance value 1 corresponds to the first exposure period, the distance value 2 corresponds to the second exposure period, and similarly, the distance values 3 to 10 correspond to the third to tenth exposure periods.

In the sub-frame period SF1_1 of the first frame period, the reflected light from the object OBJ is received in the first exposure period. FIG. 9 illustrates light emission timings L1_1, L1_2, L1_3, L1_4, and L1_5, and exposure periods E1_1, E1_2, E1_3, E1_4, and E1_5. Further, micro-frame periods MF1_1, MF1_2, MF1_3, and MF1_4 are illustrated.

In the micro-frame period MF1_1, the light emission control determination unit 104 outputs a light emission control signal indicating light emission at the light emission timing L1_1 to the light emission control unit 103 at a predetermined timing due to power-on or the like of the ranging device 200. The light emission control unit 103 controls the light emitting unit 101 based on the light emission control signal from the light emission control determination unit 104. The light emitting unit 101 emits light at the light emission timing L1_1 under the control of the light emission control unit 103. The light emission control determination unit 104 outputs a light emission start signal indicating that the light emission control is performed at the light emission timing L1_1 to the exposure period setting unit 202.

The exposure period setting unit 202 outputs an exposure control signal indicating the exposure period E1_1 to the light receiving unit 201 at the start timing of the exposure period E1_1 based on the light emission start signal from the light emission control unit 103. The exposure period E1_1 is a period in which the reflected light from the object OBJ located at the distance value 1 with respect to the light emission timing L1_1 can be received. When the reflected light from the object OBJ is incident in the exposure period E1_1 indicated by the exposure control signal, the light receiving unit 201 converts the received light into a pulse signal and outputs the pulse signal to the frequency distribution holding unit 203. The exposure period setting unit 202 outputs exposure period information indicating that the exposure period E1_1 is set in the light receiving unit 201 to the frequency distribution holding unit 203.

The frequency distribution holding unit 203 counts the pulse signal received in the exposure period E1_1 based on the pulse signal from the light receiving unit 201 and the exposure period information (exposure period E1_1) from the exposure period setting unit 202. Then, the frequency distribution holding unit 203 sets the exposure period E1_1 as a class, sets a count value obtained by counting the number of pulse signals as a frequency, and generates and holds frequency distribution information in which the class and the frequency are associated with each other.

In the micro-frame period MF1_2, the light emission control determination unit 104 outputs a light emission control signal indicating light emission at the light emission timing L1_2 to the light emission control unit 103. At this time, the light emission timing L1_2 is determined so that the light emission interval T_11 between the light emission timing L1_1 and the light emission timing L1_2 becomes shorter than the measurement period Q. Here, the light emission interval T_11 has a length corresponding to five exposure periods. Thus, the frame rate can be improved. The light emission control determination unit 104 outputs a light emission start signal indicating that the light emission control is performed at the light emission timing L1_2 to the exposure period setting unit 202.

The exposure period setting unit 202 outputs an exposure control signal indicating the exposure period E1_2 to the light receiving unit 201 at the start timing of the exposure period E1_2 based on the light emission start signal from the light emission control determination unit 104. The exposure period E1_2 is a period in which the reflected light from the object OBJ located at the distance value 1 with respect to the light emission timing L1_2 can be received. When the reflected light from the object OBJ is incident in the exposure period E1_2, the light receiving unit 201 converts the received light into a pulse signal and outputs the pulse signal to the frequency distribution holding unit 203. The exposure period setting unit 202 outputs exposure period information indicating that the exposure period E1_2 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_2) from the exposure period setting unit 202.

In the micro-frame period MF1_3, the light emission control determination unit 104 outputs a light emission control signal indicating light emission at the light emission timing L1_3 to the light emission control unit 103. Here, the light emission timing L1_3 is determined such that the length of the light emission interval T_12 from the light emission timing L1_2 to the light emission timing L1_3 is shorter than the measurement period Q and different from the length of the light emission interval T_11. Here, the light emission interval T_12 has a length corresponding to six exposure periods and is different from the light emission interval T_11 corresponding to five exposure periods. The light emission control determination unit 104 outputs a light emission start signal indicating that the light emission control is performed at the light emission timing L1_3 to the exposure period setting unit 202.

The exposure period setting unit 202 outputs an exposure control signal indicating the exposure period E1_3 to the light receiving unit 201 at the start timing of the exposure period E1_3 based on the light emission start signal from the light emission control unit 103. When the reflected light from the object OBJ is incident in the exposure period E1_3, the light receiving unit 201 converts the received light into a pulse signal and outputs the pulse signal to the frequency distribution holding unit 203. The exposure period setting unit 202 outputs exposure period information indicating that the exposure period E1_3 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_3) from the exposure period setting unit 202.

In the micro-frame period MF1_4, the light emission control determination unit 104 outputs a light emission control signal indicating light emission at the light emission timing L1_4 to the light emission control unit 103. Here, the light emission timing L1_4 is determined such that the length of the light emission interval T_13 from the light emission timing L1_3 to the light emission timing L1_4 is shorter than the measurement period Q and different from the length of the light emission interval T_12. Here, the light emission interval T_13 has a length corresponding to the five exposure periods. The light emission interval T_13 is different from the length of the light emission interval T_12 but is the same as the length of the light emission interval T_11. The light emission control determination unit 104 outputs a light emission start signal indicating that the light emission control is performed at the light emission timing L1_4 to the exposure period setting unit 202.

The exposure period setting unit 202 outputs an exposure control signal indicating the exposure period E1_4 to the light receiving unit 201 at the start timing of the exposure period E1_4 based on the light emission start signal from the light emission control unit 103. When the reflected light from the object OBJ is incident in the exposure period E1_4, the light receiving unit 201 converts the received light into a pulse signal and outputs the pulse signal to the frequency distribution holding unit 203. The exposure period setting unit 202 outputs exposure period information indicating that the exposure period E1_4 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_4) from the exposure period setting unit 202.

In the fifth micro-frame period (not illustrated), the light emission control determination unit 104 outputs a light emission control signal indicating that light is emitted at the light emission timing L1_5 to the light emission control unit 103. Here, the light emission timing L1_5 is determined such that the length of the light emission interval T_14 from the light emission timing L1_4 to the light emission timing L1_5 is shorter than the measurement period Q and different from the length of the light emission interval T_13. Here, the light emission interval T_14 is a length corresponding to six exposure periods. The light emission interval T_14 is different from the lengths of the light emission intervals T_11 and T_13 but is the same as the length of the light emission interval T_12.

In this way, the light emission control determination unit 104 controls the light emission interval so that the first light emission interval (light emission intervals T_11 and T_13) and the second light emission interval (light emission intervals T_12 and T_14) having a length different from that of the first light emission interval alternate with each other. That is, the light emission control determination unit 104 controls the light emission interval such as the first light emission interval, the second light emission interval, the first light emission interval, the second light emission interval, . . . . Here, the number of different light emission intervals is two of the first light emission interval and the second light emission interval.

The light emitting unit 101 emits light at the light emission timing L1_5 under the control of the light emission control unit 103. The light emission control determination unit 104 outputs a light emission start signal indicating that the light emission control is performed at the light emission timing L1_5 to the exposure period setting unit 202.

The exposure period setting unit 202 outputs an exposure control signal indicating the exposure period E1_5 to the light receiving unit 201 at the start timing of the exposure period E1_5 based on the light emission start signal from the light emission control determination unit 104. When the reflected light from the object OBJ is incident in the exposure period E1_5, the light receiving unit 201 converts the received light into a pulse signal and outputs the pulse signal to the frequency distribution holding unit 203. The exposure period setting unit 202 outputs exposure period information indicating that the exposure period E1_5 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_5) from the exposure period setting unit 202.

In the sub-frame period SF1_1, following the above-described fifth micro-frame period, the same processing is repeated until the micro-frame period MF1_q (q is a positive integer). As described above, in the sub-frame period SF1_1, the micro-frame period is repeated q times, and the exposure period in which the reflected light from the object OBJ located at the distance value 1 can be received is set a plurality of times (q times).

By setting the light emission interval T_11 to be shorter than the measurement period Q, the reflected light from the object OBJ located at the distance value 6 with respect to the light emission timing L1_1 can also be received in the exposure period E1_2. Similarly, the reflected light from the object OBJ located at the distance value 7 with respect to the light emission timing L1_2 can also be received in the exposure period E1_3. The reflected light from the object OBJ located at the distance value 6 with respect to the light emission timing L1_3 can also be received in the exposure period E1_4. The reflected light from the object OBJ located at the distance value 7 with respect to the light emission timing L1_4 can also be received in the exposure period E1_5.

FIG. 10 is a histogram illustrating a relationship between an exposure period and a count value of a pulse signal according to the present embodiment. In FIG. 10, a vertical axis represents the count value of the pulse signal, and a horizontal axis represents the first to tenth exposure periods (exposure periods 1 to 10). Here, for convenience of explanation, it is assumed that light other than reflected light reflected by the object OBJ is not received.

The frequency distribution holding unit 203 generates a histogram indicating the relationship between the exposure period in which the reflected light from the object OBJ located at the distance value 1 can be received and the count value of the pulse signal in the exposure period. Here, the sub-frame period SF1_1 includes 100 micro-frame periods MF1_1, MF1_2, . . . , MF1_100. When the object OBJ is located at the distance value 1, the count value of the exposure period 1 is 100 times, whereas the count values of the exposure periods 6 and 7 are half 50 times. This is because the count value of the pulse signal due to self-interference is dispersed into two because the light emitting unit 101 emits light in two light emission intervals (the first light emission interval and the second light emission interval). That is, the count value of the exposure period 1 is counted up for each light emission, whereas only one of the count values of the exposure periods 6 and 7 is counted up for each light emission.

The upper limit value M of the count value that can be recorded in the memory or the counter circuit of the frequency distribution holding unit 203 is 64. Therefore, although the count value in the exposure period 1 is theoretically 100 times, the count value is actually recorded in the frequency distribution holding unit 203 as 64 times. The count value of the exposure period 1 reaches the upper limit value M, and the count values of the exposure periods 6 and 7 are less than the upper limit value M. Note that the numerical values used here are examples for explanation, and the present embodiment is not limited thereto.

The light emission control determination unit 104 determines the light emission interval of the light emitting unit 101 based on the frequency distribution information from the frequency distribution holding unit 203 and a threshold Th. The threshold Th is a value higher than an average light reception count value obtained by averaging count values of pulse signals based on disturbance light and lower than the upper limit value M. The threshold Th is set higher than the average light reception count value in order to distinguish the disturbance light from the reflected light from the object OBJ in the histogram. Specifically, the threshold Th is set to a value (for example, 40) larger than the average of the count values in each of the exposure periods different from the exposure period in which the reflected light from the object OBJ is detected. Here, the threshold Th is set to a value larger than the average of the count values in the exposure periods 2 to 5 and 8 to 10. As a result, the influence of the disturbance light can be reduced, and the distance measurement accuracy can be improved. The threshold Th may be variable according to the brightness of the outside of the ranging device 200.

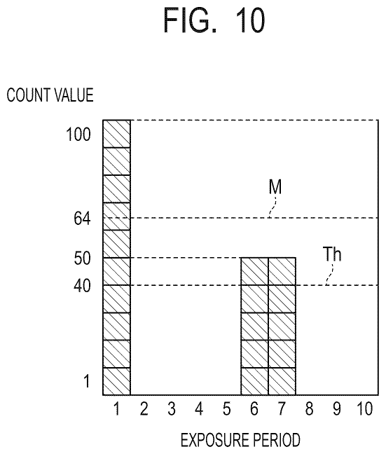

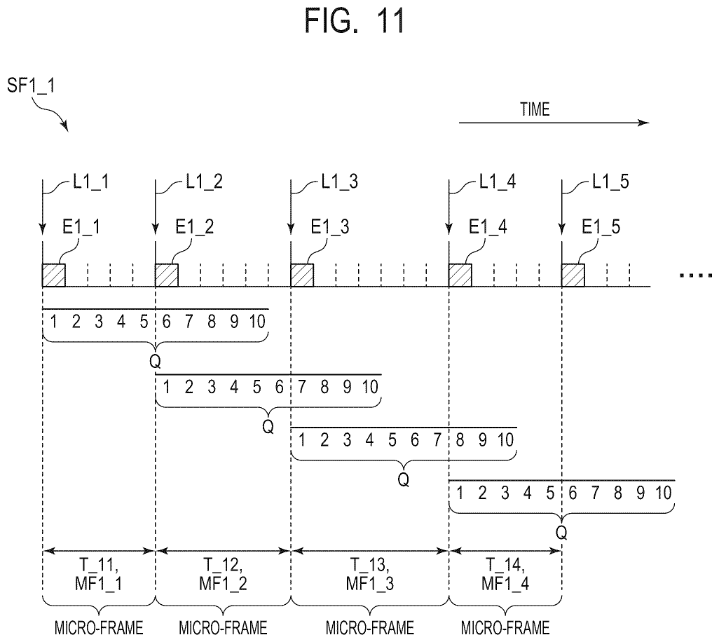

When the plurality of peak values exceed the threshold Th, the light emission control determination unit 104 starts the process of determining the light emission interval. Here, the peak value exceeds the threshold Th in the exposure periods 1, 6, and 7. Since the plurality of peak values exceed the threshold Th, the light emission control determination unit 104 increases the number of different light emission intervals. The light emission control determination unit 104 outputs a light emission control signal indicating the number of increased light emission intervals to the light emission control unit 103. Specific control for increasing the number of light emission intervals will be described with reference to FIG. 11.

FIG. 11 is a timing chart illustrating a control example of a light emission interval and an exposure period according to the present embodiment. In FIG. 11, description of the same control as that of the timing chart of FIG. 9 is appropriately omitted.

In the sub-frame period SF1_1 of the second frame period, the reflected light from the object OBJ is received in the first exposure period. FIG. 11 illustrates light emission timings L1_1, L1_2, L1_3, L1_4, and L1_5, and exposure periods E1_1, E1_2, E1_3, E1_4, and E1_5. Further, micro-frame periods MF1_1, MF1_2, MF1_3, and MF1_4 are illustrated.

In the micro-frame period MF1_1, the light emission control determination unit 104 outputs a light emission control signal indicating light emission at the light emission timing L1_1 to the light emission control unit 103. Then, the light emission control determination unit 104 outputs a light emission start signal indicating that the light emission control is performed at the light emission timing L1_1 to the exposure period setting unit 202.

The exposure period setting unit 202 outputs an exposure control signal indicating the exposure period E1_1 to the light receiving unit 201 based on the light emission start signal from the light emission control unit 103. The exposure period setting unit 202 outputs exposure period information indicating that the exposure period E1_1 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_1) from the exposure period setting unit 202.

In the micro-frame period MF1_2, the light emission control determination unit 104 outputs a light emission control signal indicating light emission at the light emission timing L1_2 to the light emission control unit 103. At this time, the light emission interval T_11 between the light emission timing L1_1 and the light emission timing L1_2 has a length corresponding to five exposure periods. The light emission control determination unit 104 outputs a light emission start signal indicating that the light emission control is performed at the light emission timing L1_2 to the exposure period setting unit 202.

The exposure period setting unit 202 outputs an exposure control signal indicating the exposure period E1_2 to the light receiving unit 201 based on the light emission start signal from the light emission control unit 103. The exposure period setting unit 202 outputs exposure period information indicating that the exposure period E1_2 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_2) from the exposure period setting unit 202.

In the micro-frame period MF1_3, the light emission control determination unit 104 outputs a light emission control signal indicating light emission at the light emission timing L1_3 to the light emission control unit 103. At this time, the light emission interval T_12 between the light emission timing L1_2 and the light emission timing L1_3 has a length corresponding to the six exposure periods. The light emission control determination unit 104 outputs a light emission start signal indicating that the light emission control is performed at the light emission timing L1_3 to the exposure period setting unit 202.

The exposure period setting unit 202 outputs an exposure control signal indicating the exposure period E1_3 to the light receiving unit 201 based on the light emission start signal from the light emission control unit 103. The exposure period setting unit 202 outputs exposure period information indicating that the exposure period E1_3 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_3) from the exposure period setting unit 202.

In the micro-frame period MF1_4, the light emission control determination unit 104 outputs a light emission control signal indicating light emission at the light emission timing L1_4 to the light emission control unit 103. At this time, the light emission interval T_13 between the light emission timing L1_3 and the light emission timing L1_4 has a length corresponding to seven exposure periods. The light emission control determination unit 104 outputs a light emission start signal indicating that the light emission control is performed at the light emission timing L1_4 to the exposure period setting unit 202.

The exposure period setting unit 202 outputs an exposure control signal indicating the exposure period E1_4 to the light receiving unit 201 based on the light emission start signal from the light emission control unit 103. The exposure period setting unit 202 outputs exposure period information indicating that the exposure period E1_4 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_4) from the exposure period setting unit 202.

In the fifth micro-frame period (not illustrated), the light emission control determination unit 104 outputs a light emission control signal indicating that light is emitted at the light emission timing L1_5 to the light emission control unit 103. At this time, a light emission interval T_14 between the light emission timing L1_4 and the light emission timing L1_5 has a length corresponding to five exposure periods. The light emission control determination unit 104 outputs a light emission start signal indicating that the light emission control is performed at the light emission timing L1_5 to the exposure period setting unit 202.

The exposure period setting unit 202 outputs an exposure control signal indicating the exposure period E1_5 to the light receiving unit 201 based on the light emission start signal from the light emission control unit 103. The exposure period setting unit 202 outputs exposure period information indicating that the exposure period E1_5 is set in the light receiving unit 201 to the frequency distribution holding unit 203.

The frequency distribution holding unit 203 generates and holds frequency distribution information based on the pulse signal from the light receiving unit 201 and the exposure period information (exposure period E1_5) from the exposure period setting unit 202.

As described above, the light emission control determination unit 104 controls the light emission interval in the first light emission interval (light emission intervals T_11 and T_14), the second light emission interval (light emission interval T_12) having a length different from that of the first light emission interval, and the third light emission interval (light emission interval T_13) having a length different from that of the first and second light emission intervals. That is, the light emission control determination unit 104 controls the light emission interval such as the first light emission interval, the second light emission interval, the third light emission interval, the first light emission interval, the second light emission interval, the third light emission interval, . . . . Here, the number of different light emission intervals is three of the first light emission interval, the second light emission interval, and the third light emission interval.

By setting the light emission interval T_11 to be shorter than the measurement period Q, the reflected light from the object OBJ located at the distance value 6 with respect to the light emission timing L1_1 can also be received in the exposure period E1_2. Similarly, the reflected light from the object OBJ located at the distance value 7 with respect to the light emission timing L1_2 can also be received in the exposure period E1_3. The reflected light from the object OBJ located at the distance value 8 with respect to the light emission timing L1_3 can also be received in the exposure period E1_4. The reflected light from the object OBJ located at the distance value 6 with respect to the light emission timing L1_4 can also be received in the exposure period E1_5.

FIG. 12 is a histogram illustrating a relationship between an exposure period and a count value of a pulse signal according to the present embodiment. Here, for convenience of explanation, it is assumed that light other than reflected light reflected by the object OBJ is not received. The frequency distribution holding unit 203 generates a histogram indicating the relationship between the exposure period in which the reflected light from the object OBJ located at the distance value 1 can be received and the count value in the exposure period. Here, the sub-frame period SF1_1 includes 100 micro-frame periods MF1_1, MF1_2, . . . , MF1_100. When the object OBJ is located at the distance value 1, the count value of the exposure period 1 is 100 times, whereas the count values of the exposure periods 6, 7, and 8 are 33 times of about ⅓. This is because the light emitting unit 101 emits light in three light emission intervals (the first light emission interval, the second light emission interval, and the third light emission interval), and thus the count of the pulse signal due to self-interference is dispersed into three. That is, the count value of the exposure period 1 is counted up for each light emission, whereas only one of the count values of the exposure periods 6, 7, and 8 is counted up for each light emission.

The count values in the exposure periods 6, 7, and 8 are less than the threshold Th, and only the count value in the exposure period 1 exceeds the threshold Th. Accordingly, only the count value of the exposure period 1 is detected as the peak value.

As described above, the ranging device 200 according to the present embodiment includes the light emission control determination unit 104 that determines the light emission condition of the light emitting unit 101 based on the frequency distribution information. Accordingly, the ranging device 200 can generate more appropriate frequency distribution information according to the light emission condition, and can accurately measure the distance to the object OBJ.

In the ranging device 200, when a plurality of peak values exceed the threshold Th in the first frame period, the light emission control determination unit 104 increases the number of different light emission intervals in the first frame period in the second frame period after the first frame period. Accordingly, the ranging device 200 can reduce the count value due to self-interference and thus can increase the SN ratio. Therefore, the ranging device 200 can measure the distance to the object OBJ with high accuracy.

Although the ranging device 200 controls the light emission interval based on the comparison between the count value and the threshold Th, the light emission interval may be controlled based on the shape of the histogram, that is, the distribution of the count values in the frequency distribution information. The ranging device 200 may control the light emission interval so that a difference between a count value (maximum peak value) corresponding to the distance to the object OBJ and another count value becomes large.

In addition, although the ranging device 200 increases the number of light emission intervals by one for each frame period, the number of light emission intervals increased for each frame period may be plural.

Although the ranging device 200 controls the light emission interval as the light emission condition, other light emission conditions may be controlled. For example, the ranging device 200 may control at least one of the number of shots and the light emission intensity instead of or together with the light emission interval. The control of the number of shots and the emission intensity can be the same as the control in the first to third embodiments.

### Fifth Embodiment

The present embodiment is different from the first embodiment in that the processing is performed not for all of the light receiving regions of the light receiving unit but for a part of the light receiving regions. The hardware configuration of the ranging device according to the present embodiment is different from that of the ranging device 100 according to the first embodiment in the configurations of the light emitting unit and the light emission control unit, and the other configurations are the same.

The light emitting unit includes a plurality of light emitting regions, and each of the light emitting regions includes a plurality of light emitting elements. The light emission control determination unit 104 determines the number of shots for each light emission region, and outputs a light emission control signal indicating the determined number of shots to the light emission control unit. The light emission control unit receives the light emission control signal from the light emission control determination unit 104 and individually controls each light emission region.

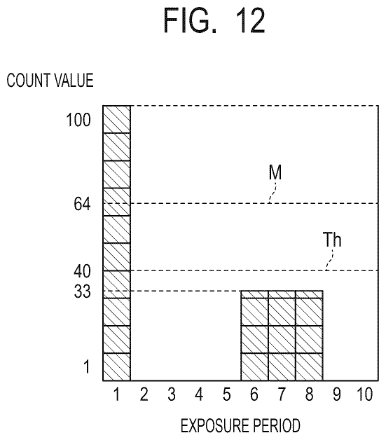

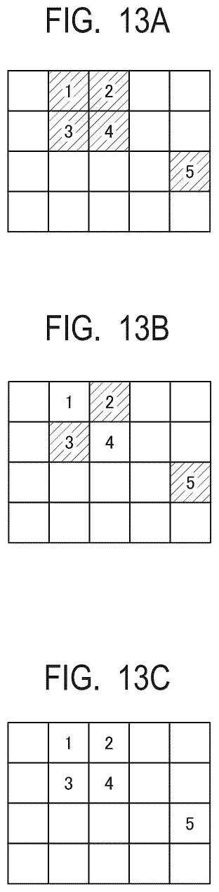

The light receiving unit 102 includes a plurality of light receiving regions respectively corresponding to the light emitting regions. That is, the reflected light caused by the pulse light emitted from the first light emitting region of the light emitting unit can be received by the first light receiving region of the light receiving unit 102, and the reflected light caused by the pulse light emitted from the second light emitting region of the light emitting unit can be received by the second light receiving region of the light receiving unit 102. Similarly, the reflected light caused by the pulse light emitted from the N-th light emitting region of the light emitting unit can be received by the N-th light receiving region of the light receiving unit 102. Each of the light receiving regions includes a plurality of pixels. FIGS. 13A to 13C are diagrams illustrating one light receiving region in the light receiving unit 102 according to the present embodiment. In FIGS. 13A to 13C, only one light receiving region among a plurality of light receiving regions is illustrated for convenience of explanation. The light receiving area is composed of a total of 20 pixels of 5×4 pixels. Although an example in which the light receiving region is formed of 5×4 pixels has been described, the present embodiment is not limited thereto, and the light receiving region may be formed of other numbers of pixels.

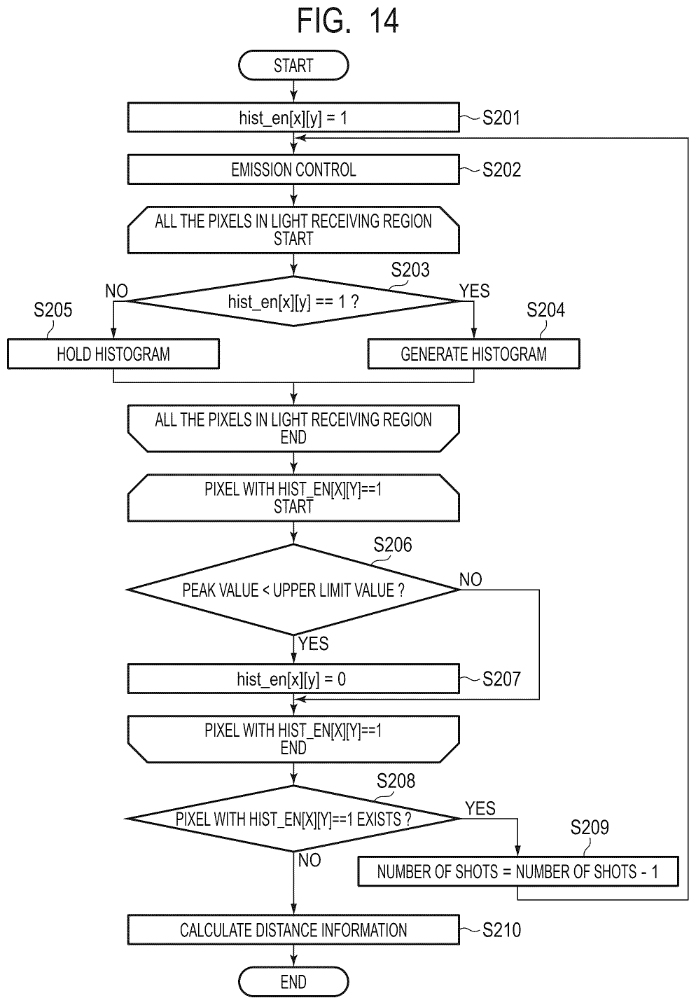

FIG. 14 is a flowchart illustrating an operation of a ranging device according to the present embodiment. In FIG. 14, a variable hist_en[x][y] is a variable that holds information indicating whether or not to generate a histogram for each pixel in the light receiving region. In the variable hist_en[x][y], x represents a horizontal coordinate in the light receiving region, and y represents a vertical coordinate in the light receiving region. By specifying x and y, a target pixel in the light receiving region is specified. When the variable hist_en[x][y] is 1, it indicates that a histogram of the target pixel is generated, and when the variable hist_en[x][y] is 0, it indicates that a histogram of the target pixel is not generated.

In step S201, the frequency distribution holding unit 108 sets 1 to the variable hist_en[x][y] of all the pixels in the light receiving region.

In step S202, the light emission control determination unit 104 outputs a light emission control signal indicating a predetermined number of shots to the light emission control unit. The light emission control unit controls the light emitting unit based on the light emission control signal from the light emission control determination unit 104. Here, the light emission control unit causes only one of the light emission regions of the light emitting unit to emit light. The light receiving unit 102 receives the reflected light caused by the pulse light emitted from the light emitting region in the light receiving region corresponding to the light emitting region.

In step S203, the frequency distribution holding unit 108 determines whether or not the variable hist_en[x][y] is 1 for the pixels in the light receiving region. When the variable hist_en[x][y] is 1 (step S203; YES), the process proceeds to step S204.

In step S204, the frequency distribution holding unit 108 generates a histogram. When the histogram already exists, the frequency distribution holding unit 108 updates the histogram generated in this step.

In step S203, when the variable hist_en[x][y] is 0 (step S203; NO), the process proceeds to step S205. In step S205, the frequency distribution holding unit 108 holds the generated histogram without generating a new histogram.

The frequency distribution holding unit 108 performs the processing of steps S203 to S205 on all the pixels (20 pixels) in the light receiving region.

In step S206, the frequency distribution holding unit 108 determines whether or not the peak value is less than the upper limit value M in the pixel in which the variable hist_en[x][y] is 1.

When the peak value is less than the upper limit value M (step S206; YES), the process proceeds to step S207. In step S207, the frequency distribution holding unit 108 sets the variable hist_en[x][y] to 0.

When the peak value is not less than the upper limit value M (step S206; NO), the frequency distribution holding unit 108 skips the process of step S207 and does not set 0 to the variable hist_en[x][y]. That is, a state in which 1 is set to the variable hist_en[x][y] is maintained.

Here, as illustrated in FIG. 13A, 1 is set to the variable hist_en[x][y] for 5 pixels out of 20 pixels in the light receiving region. These five pixels are represented by pixels 1 to 5 and are hatched with diagonal lines. A variable hist_en[x][y] is set to 0 for pixels other than the pixels 1 to 5 among the 20 pixels in the light receiving region.

The frequency distribution holding unit 108 performs the processing of steps S206 to S207 only on the pixels whose variable hist_en[x][y] is 1 among all the pixels in the light receiving region.

In step S208, the frequency distribution holding unit 108 determines whether or not a pixel in which the variable hist_en[x][y] is 1 exists in the light receiving region. If there is a pixel whose variable hist_en[x][y] is 1 in the light receiving region (step S208; YES), the process proceeds to step S209.

In step S209, the light emission control determination unit 104 subtracts the number of shots. The number of shots in the second frame period is set to the number of shots obtained by subtracting 1 from the number of shots in the first frame period. Then, returning to step S202, the light emission control unit causes the same light emission region to emit light based on the number of shots after subtraction.

Here, the light receiving region in FIG. 13B is a state after the processing of steps S202 to S209 is repeated a plurality of times. The pixels 1 and 4 indicate that the peak value is less than the upper limit value M in all the bin periods. That is, the variable hist_en[x][y] of the pixels 1 and 4 is 0. In the pixels 2, 3, and 5, the peak value still reaches the upper limit value M. That is, the variable hist_en[x][y] of the pixels 2, 3, and 5 is 1.

The light receiving region in FIG. 13C is a state after the processes of steps S202 to S209 are further repeated a plurality of times. This indicates that the peak values of the pixels 1 to 5 are less than the upper limit value M. That is, the variable hist_en[x][y] of the pixels 1 to 5 is 0. Thus, the variable hist_en[x][y] of all the pixels in the light receiving region is 0. When there is no pixel whose variable hist_en[x][y] is 1 in the light receiving region (step S208; NO), the process proceeds to step S210.

In step S210, the distance calculation unit 109 calculates distance information for each pixel from the histogram of each pixel in the light reception region. As a result, the calculation of the distance information with respect to one of the light receiving regions of the light receiving unit 102 is ended. Similarly, the processes of steps S201 to S210 are performed on other light receiving regions among the light receiving regions of the light receiving unit 102.

As described above, according to the ranging device of the present embodiment, the light emission control determination unit 104 determines the number of shots for each light receiving region. Specifically, the light emission control determination unit 104 determines the number of shots so that the peak value is smaller than the upper limit value M in each of the pixels included in the light reception region. Accordingly, since the ranging device updates the histogram for each light receiving region, the generation of the histogram can be reduced, and the amount of calculation can be reduced as compared with the ranging device 100 according to the first embodiment.

When the first pixel whose peak value reaches the upper limit value M is included in the light receiving region in the first frame period, the light emission control determination unit 104 reduces the number of shots of the light emitting region in the second frame period after the first frame period. The frequency distribution holding unit 108 updates the histogram of the first pixel acquired in the second frame period. On the other hand, when the second pixel whose peak value is smaller than the upper limit value M is included in the light receiving region in the first frame period, the frequency distribution holding unit 108 does not update the histogram of the second pixel in the second frame period. As a result, the ranging device can reduce the generation of the histogram and can further reduce the amount of calculation compared to the ranging device 100 according to the first embodiment.

Note that the light emission control determination unit 104 may control the light emission intensity and the light emission interval instead of or together with the number of shots.

### Sixth Embodiment

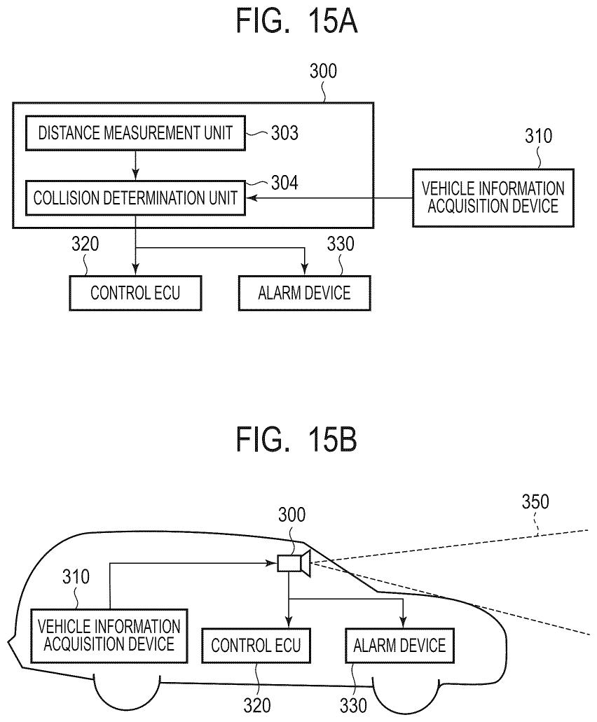

FIGS. 15A and 15B are diagrams illustrating a configuration example of a movable body according to the sixth embodiment.

FIG. 15A illustrates a configuration example of an equipment mounted on a vehicle as an in-vehicle camera. The device 300 includes a distance measurement unit 303 that measures a distance to an object, and a collision determination unit 304 that determines whether there is a possibility of collision based on the distance measured by the distance measurement unit 303. The distance measurement unit 303 may be configured by the ranging devices 100 and 200 described in the above embodiments. Here, the distance measurement unit 303 is an example of a distance information acquisition unit that acquires distance information to an object. That is, the distance information is related to a distance to an object or the like.

The device 300 is connected to the vehicle information acquisition device 310 and can acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the device 300. The device 300 is also connected to an alarm device 330 that issues an alarm to the driver based on the determination result of the collision determination unit 304. For example, when the determination result of the collision determination unit 304 indicates that the possibility of collision is high, the control ECU 320 performs vehicle control to avoid collision and reduce damage by applying a brake, returning an accelerator, suppressing engine output, or the like. The alarm device 330 gives an alarm to the user by sounding an alarm such as a sound, displaying alarm information on a screen of a car navigation system or the like, giving vibration to a seat belt or a steering wheel, or the like. These devices of the device 300 function as a movable body control unit that controls the operation of controlling the vehicle as described above.

In the present embodiment, the distance to the surroundings of the vehicle, for example, the front or the rear is measured by the device 300. FIG. 15B illustrates an equipment in a case where distance measurement is performed in front of the vehicle (distance measurement range 350). The vehicle information acquisition device 310 serving as the distance measurement control unit sends an instruction to the device 300 or the distance measurement unit 303 to perform the distance measurement operation. With such a configuration, the accuracy of distance measurement can be further improved.

In the above description, an example in which control is performed so as not to collide with another vehicle has been described, but the present embodiment is also applicable to control in which automatic driving is performed so as to follow another vehicle, control in which automatic driving is performed so as not to protrude from a lane, and the like. Furthermore, the device is not limited to vehicles such as automobiles, and can be applied to, for example, ships, aircrafts, artificial satellites, industrial robots, consumer robots, and the like movable body (mobile devices). In addition, the present embodiment is not limited to the movable body and can be widely applied to devices utilizing object recognition or biological recognition, such as an intelligent traffic system (ITS) and a monitoring system.

### Modified Embodiments

The present invention is not limited to the above-described embodiment, and various modifications are possible. For example, an example in which a part of the configuration of any of the embodiments is added to another embodiment or an example in which a part of the configuration of another embodiment is replaced with another embodiment is also an embodiment of the present invention.

For example, the present invention may supply a program for realizing one or more functions of each embodiment to a ranging device via a network or a recording medium. The present invention can also be realized by a process in which one or more processors in a computer of a ranging device read and execute a program.

In addition, although an example in which the frequency distribution information is represented by a histogram has been described, the frequency distribution information is not limited thereto, and for example, the frequency distribution may be represented in a table format, and the form of the information is not limited.

According to the present disclosure, it is possible to realize a ranging device and a ranging method capable of accurately measuring a distance.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-166165, filed Sep. 25, 2024, which is hereby incorporated by reference herein in its entirety.

What is claimed is:

1. A ranging device comprising:
a light emission control unit configured to control a light emitting unit that emits a pulse light according to a light emission condition;
a light receiving unit configured to detect reflected light emitted from the light emitting unit and reflected by an object and convert the reflected light into a pulse signal;
an exposure period setting unit configured to set an exposure period for detecting the reflected light;
a holding unit configured to hold frequency distribution information in which a count value of the pulse signal is associated with each of a plurality of exposure periods; and
a determination unit configured to determine the light emission condition based on the frequency distribution information.

2. The ranging device according to claim 1, wherein the determination unit determines the light emission condition such that the count value in the frequency distribution information is smaller than a predetermined upper limit value.

3. The ranging device according to claim 2, wherein the upper limit value is a maximum value of the count value recorded in the holding unit.

4. The ranging device according to claim 2, wherein the upper limit value is smaller than a maximum value of the count value recorded in the holding unit.

5. The ranging device according to claim 2,
wherein the determination unit determines the light emission condition for each frame period in which distance information to the object is calculated, and
wherein in a case where a peak value of the count value reaches the upper limit value in a first frame period, the determination unit reduces at least one of the number of times of light emission of the light emitting unit and light emission intensity of the light emitting unit in the first frame period by a predetermined number in a second frame period after the first frame period.

6. The ranging device according to claim 5, wherein in a case where a plurality of the peak values reaches the upper limit value in the first frame period, the determination unit reduces at least one of the number of times of light emission and the light emission intensity in the first frame period by a number larger than the predetermined number in the second frame period.

7. The ranging device according to claim 5, wherein when the peak value is equal to or less than a lower limit value lower than the upper limit value in the first frame period, the determination unit increases at least one of the number of times of light emission and the light emission intensity in the first frame period in the second frame period.

8. The ranging device according to claim 5, wherein the predetermined number is a value calculated from at least one of the number of times of light emission and the light emission intensity in the first frame period.

9. The ranging device according to claim 8, wherein the predetermined number is a value obtained by dividing at least one of the number of times of light emission and the light emission intensity in the first frame period by a predetermined divisor.

10. The ranging device according to claim 2, wherein when a plurality of peak values of the count value exceed a threshold value lower than the upper limit value, the determination unit starts a process of determining the light emission condition.

11. The ranging device according to claim 10, wherein the threshold value is higher than an average light reception count value of the pulse signal based on disturbance light.

12. The ranging device according to claim 1,
wherein the light emitting unit includes a plurality of light emitting regions,
wherein the light receiving unit includes a plurality of light receiving regions respectively corresponding to the plurality of light emitting regions, and each of the plurality of light receiving regions includes a plurality of pixels,
wherein the holding unit holds the frequency distribution information for each of the pixels, and
wherein the determination unit determines the light emission condition for each of the light reception regions.

13. The ranging device according to claim 12, wherein the determination unit determines the light emission condition such that a peak value of the count value is smaller than a predetermined upper limit value in each of the plurality of pixels included in the light reception region.

14. The ranging device according to claim 13,
wherein when a first pixel whose peak value reaches the upper limit value is included in the light receiving regions in a first frame period, the determination unit reduces at least one of the number of times of light emission of the light emitting unit and light emission intensity of the light emitting unit in a second frame period after the first frame period, and
wherein the holding unit updates the frequency distribution information of the first pixel.

15. The ranging device according to claim 14, wherein when a second pixel whose peak value is smaller than the upper limit value is included in the light receiving regions in the first frame period, the holding unit does not update the frequency distribution information of the second pixel in the second frame period.

16. The ranging device according to claim 1,
wherein the light emitting unit emits light at a plurality of different light emission intervals,
wherein the determination unit determines the light emission condition for each frame period in which distance information to the object is calculated, and
wherein when a plurality of peak values of the count values exceed a predetermined threshold in a first frame period, the determination unit increases the number of the plurality of light emission intervals in the first frame period in a second frame period after the first frame period.

17. A movable body comprising:
the ranging device according to claim 1; and
a control unit configured to control the movable body based on distance information acquired by the ranging device.

18. A ranging method comprising:
controlling a light emitting unit that emits a pulse light according to a light emitting condition;
detecting reflected light emitted from the light emitting unit and reflected by an object and converting the reflected light into a pulse signal;
holding, in a holding unit, frequency distribution information in which a count value of the pulse signal is associated with each of a plurality of bin periods obtained by dividing a period from an emission timing of the pulse light to a measurement end timing of the reflected light; and
determining the light emission condition based on the frequency distribution information.

19. A ranging method comprising:
controlling a light emitting unit that emits a pulse light according to a light emitting condition;
detecting reflected light emitted from the light emitting unit and reflected by an object and converting the reflected light into a pulse signal;
setting an exposure period for detecting the reflected light;
holding, in a holding unit, frequency distribution information in which a count value of the pulse signal is associated with each of the plurality of exposure periods; and
determining the light emission condition based on the frequency distribution information.
